(19) United States
(12) Patent Application Publication
(10) Pub. No.: US 2011/0025663 A1
(43) Pub. Date: Feb. 3, 2011

(54) DISPLAY APPARATUS AND METHOD OF DRIVING THE SAME

(76) Inventor: Young-Min Bae, Yongin-city (KR)

Correspondence Address: CHRISTIE, PARKER & HALE, LLP, PO BOX 7068, PASADENA, CA, 91109-7068, US

(21) Appl. No.: 12/730,054

(22) Filed: Mar. 23, 2010

(30) Foreign Application Priority Data
Aug. 3, 2009 (KR) 10-2009-0071300

(51) Int. Cl. G06F 3/038

(52) U.S. Cl. 345/209; 345/82

(57) ABSTRACT

A display apparatus includes: a display region including a plurality of pixels; a data driver for outputting data voltages corresponding to input data to the plurality of pixels; and a scan driver for outputting scan signals to the plurality of pixels, wherein the plurality of pixels includes a first pixel group and a second pixel group, and wherein the first pixel group and the second pixel group have offset voltages having different polarities in a first frame, and the polarities of the offset voltages are inverted for each frame after the first frame.

### CROSS-REFERENCE TO RELATED PATENT APPLICATION

This application claims the benefit of Korean Patent Application No. 10-2009-0071300, filed on Aug. 3, 2009, in the Korean Intellectual Property Office, the content of which is incorporated herein in its entirety by reference.

### BACKGROUND

1. Field

The following description relates to a display apparatus and a method of driving the same.

2. Description of the Related Art

Display apparatuses control brightness of each of a plurality of pixels by applying a data voltage corresponding to input data to each pixel, and converting the input data into an image and displaying the image to a user. The data voltages to be output to a display region of the display apparatus may be generated by a data driver, and the data driver may output the data voltages to the display region by using an output amplifier. The output amplifier may be implemented as an amplifier which receives a differential input signal. Due to the internal structure of the output amplifier, an undesired offset may occur. An offset may also occur due to variations in several parameters, such as channel widths and lengths of transistors which receive a differential input signal of the output amplifier. Due to such offset, the magnitude of the data voltages applied to each pixel varies, and the brightness of each pixel therefore also varies.

Thus, in display apparatuses such as active matrix organic light emitting diode (AMOLED) displays, the uniformity of data voltage channels must be maintained so that a line-shaped mura defect does not occur in the vertical axis on a screen. However, due to the difference in voltages output from each of the data voltage channels, the mura defect occurs.

To address this problem, algorithms have been created to remove or reduce an offset generated in an output amplifier. FIG. 1 illustrates a conventional offset removal algorithm. Referring to FIG. 1, in the conventional offset removal algorithm, a polarity of an offset voltage is inverted in each frame, so that the effect of offsets that are generated is averaged. For example, as illustrated in FIG. 1, each odd-numbered frame 102 may have a negative offset L, and each even-numbered frame 104 may have a positive offset H. However, here, when a brightness difference increases due to an offset between frames, flickering may occur on the screen.

FIG. 2 illustrates an example of levels of voltages output from each data voltage channel according to the conventional offset removal algorithm shown in FIG. 1.

Specifically, FIG. 2 illustrates the case where, in order to remove or reduce an offset associated with first and second frames according to the conventional offset removal algorithm, a difference between adjacent data voltage channels is reduced by averaging the offset in each of the first and second frames. In such a conventional offset removal algorithm, when the size of a component of the positive offset H in the first frame and the size of a component of the negative offset L in the second frame are large, the difference between the adjacent data voltage channels is reduced. However, due to a difference in direct current (DC) components between the first and second frames, flickering occurs on the screen.

### SUMMARY OF THE INVENTION

Exemplary embodiments of the present invention provide a display apparatus which reduces differences between adjacent data voltage channels generated at a data voltage output terminal, and provides an offset removal algorithm for preventing flickering from occurring on a screen, and a method of driving the same.

According to an aspect of an exemplary embodiment of the present invention, there is provided a display apparatus, the display apparatus including: a display region including a plurality of pixels; a data driver for outputting data voltages corresponding to input data to the plurality of pixels; and a scan driver for outputting scan signals to the plurality of pixels, wherein the plurality of pixels includes a first pixel group and a second pixel group, wherein the first pixel group and the second pixel group have offset voltages having different polarities in a first frame, and the polarities of the offset voltages are inverted for each frame after the first frame.

The first pixel group and the second pixel group may be arranged in a dot pattern.

The data driver may include a plurality of data voltage outputting units for outputting the data voltages to the plurality of pixels via a plurality of data voltage channels, wherein the plurality of data voltage outputting units includes a first group of outputting units and a second group of outputting units alternately arranged and having offset voltages having different polarities, and wherein the polarities of the offset voltages for the first group of outputting units and the second group of outputting units are inverted for each scan period.

The data driver may further include an offset voltage controller for outputting a first offset voltage control signal to the first group of outputting units and for outputting a second offset voltage control signal to the second group of outputting units, and wherein the first offset voltage control signal and the second offset voltage control signal have different logic levels and are utilized to invert the polarities of the offset voltages of the first group of outputting units and the second group of outputting units for each scan period, and to invert the polarities of the offset voltages of the first pixel group and the second pixel group for each frame.

The first pixel group and the second pixel group may be alternately arranged in a line pattern.

The data driver may further include a plurality of data voltage outputting units for outputting the data voltages to the plurality of pixels via a plurality of data voltage channels, and wherein polarities of the offset voltages of the plurality of data voltage outputting units are inverted for each scan period.

The data driver may further include an offset voltage controller for outputting an offset voltage control signal to the plurality of data voltage outputting units, and wherein the offset voltage control signal is utilized to invert the polarities of the offset voltages of the plurality of data voltage outputting units for each scan period, and to invert the polarities of the offset voltages of the first pixel group and the second pixel group for each frame.

Each of the plurality of pixels may include an organic light emitting diode (OLED).

According to an aspect of another exemplary embodiment of the present invention, there is provided a method of driving a display apparatus including a display region including a plurality of pixels, a data driver for outputting data voltages corresponding to input data to the plurality of pixels, and a scan driver for outputting scan signals to the plurality of pixels, wherein the plurality of pixels includes a first pixel group pixels and a second pixel group, the method including: controlling the first pixel group and the second pixel group to have offset voltages having different polarities in a first frame; and inverting the polarities of the offset voltages of the first pixel group and the second pixel group for each frame after the first frame.

The first pixel group and the second pixel group may be arranged in a dot pattern.

The data driver may include a plurality of data voltage outputting units for outputting the data voltages to the plurality of pixels via a plurality of data voltage channels, wherein the plurality of data voltage outputting units includes a first group of outputting units and a second group of outputting units alternately arranged, wherein the controlling of the first pixel group and the second pixel group includes controlling the first group of outputting units and the second group of outputting units to have offset voltages having different polarities, and inverting the polarities of the offset voltages for the first group of outputting units and the second group of outputting units for each scan period, and wherein the inverting of the polarities of the offset voltages of the first pixel group and the second pixel group includes controlling the first group of outputting units and the second group of outputting units to invert the polarities of the offset voltages of the first pixel group pixel and the second pixel group for each frame.

The first pixel group and the second pixel group may be alternately arranged in a line pattern.

The data driver may further include a plurality of data voltage outputting units for outputting the data voltages to the plurality of pixels via a plurality of data voltage channels, wherein the controlling of the first pixel group and the second pixel group includes inverting the polarities of the offset voltages of the plurality of data voltage outputting units for each scan period, and wherein the inverting of the polarities of the offset voltages of the first pixel group and the second pixel group includes controlling the plurality of data voltage outputting units to invert the polarities of the offset voltages of the first pixel group and the second pixel group for each frame.

### BRIEF DESCRIPTION OF THE DRAWINGS

The above and other features and advantages of the present invention will become more apparent by describing in detail exemplary embodiments thereof with reference to the attached drawings in which:

FIG. 1 schematically illustrates a conventional offset removal algorithm;

FIG. 2 illustrates levels of voltages output from data voltage channels according to the conventional offset removal algorithm shown in FIG. 1;

FIG. 3 schematically illustrates an offset removal algorithm according to an embodiment of the present invention;

FIG. 4 schematically illustrates an offset removal algorithm according to another embodiment of the present invention;

FIG. 5 schematically illustrates the structure of a display apparatus according to an embodiment of the present invention;

FIG. 6 schematically illustrates the structure of a data driver of the display apparatus shown in FIG. 5 according to an embodiment of the present invention;

FIG. 7 is a timing diagram illustrating a first offset voltage control signal and a second offset voltage control signal according to an embodiment of the present invention;

FIG. 8 is a flowchart illustrating a method of driving a display apparatus according to an embodiment of the present invention;

FIG. 9 schematically illustrates the structure of a driver unit of the display apparatus shown in FIG. 5 according to another embodiment of the present invention;

FIG. 10 is a timing diagram illustrating a third offset voltage control signal according to another embodiment of the present invention; and

FIG. 11 is a flowchart illustrating a method of driving a display apparatus according to another embodiment of the present invention.

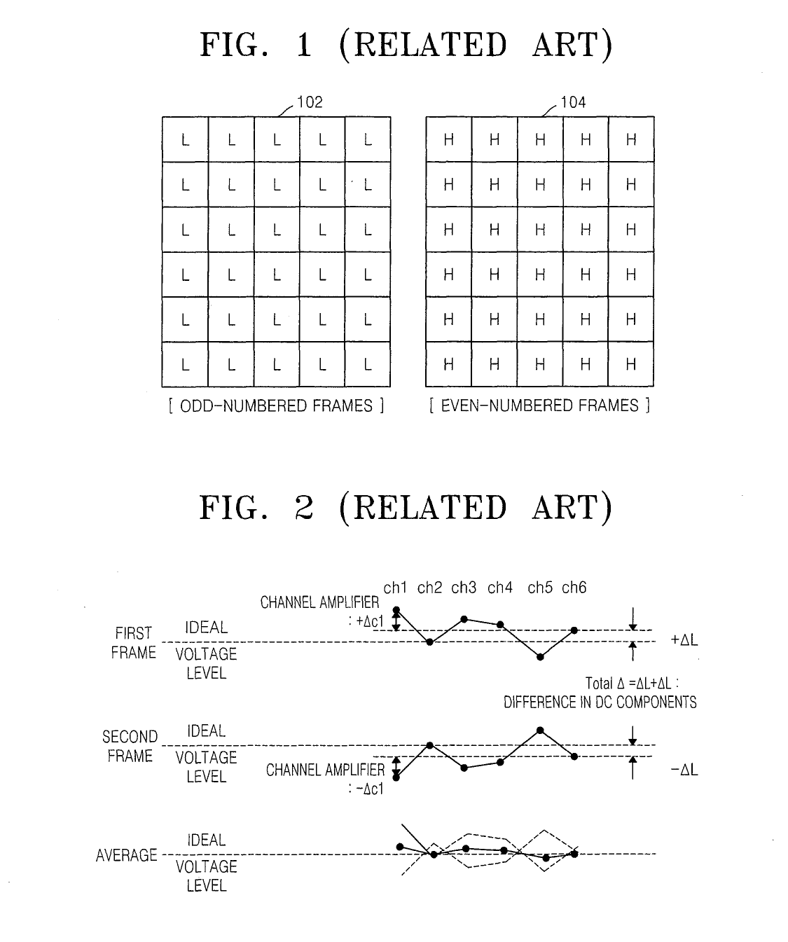

### DETAILED DESCRIPTION

The attached drawings illustrate exemplary embodiments of the present invention, and are described in order to gain an understanding of the present invention. Hereinafter, the present invention will be described in detail by describing the following exemplary embodiments with reference to the attached drawings.

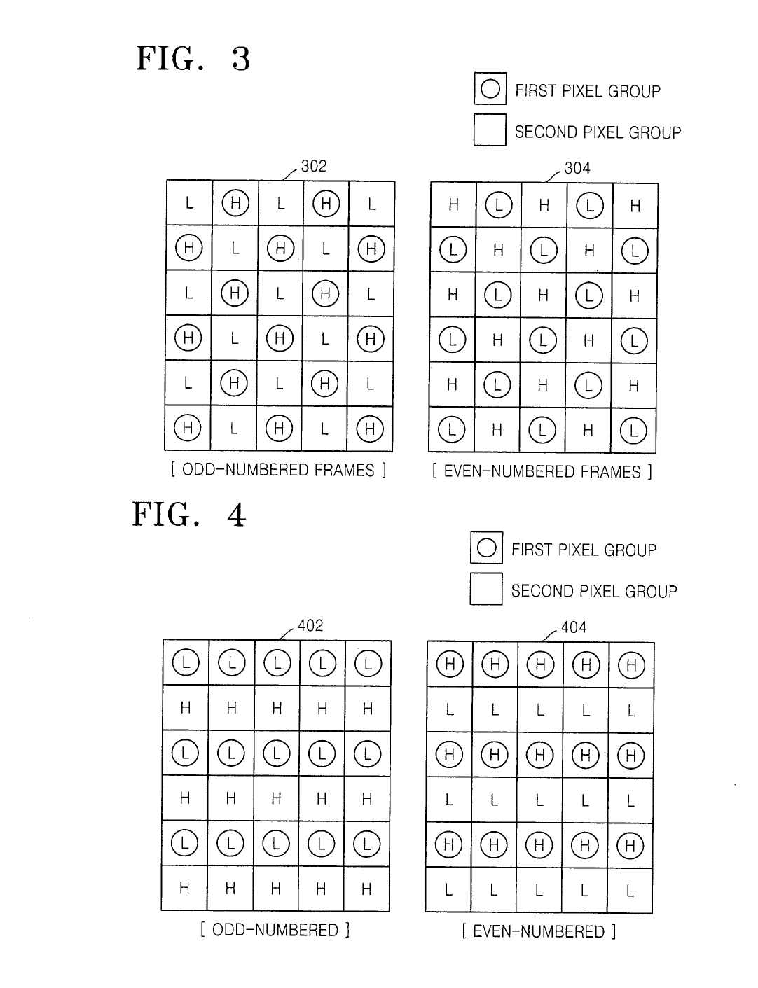

FIG. 3 schematically illustrates an offset removal algorithm according to an embodiment of the present invention.

According to an embodiment of the present invention, the polarity of an offset voltage is inverted using a dot inversion method. Referring to FIG. 3, a plurality of pixels included in a display region are arranged in dot patterns, and are classified into a first pixel group and a second pixel group, which are alternately arranged. The first pixel group and the second pixel group are controlled to have different offset voltage polarities, and the offset voltage polarities of the first pixel group and the second pixel group are inverted in each of a plurality of frames. For example, as illustrated in FIG. 3, in odd-numbered frames 302, each of the pixels of the first pixel group has a positive offset voltage polarity H, and each of the pixels of the second pixel group has a negative offset voltage polarity L, and in even-numbered frames 304, each of the pixels of the first pixel group has a negative offset voltage polarity L, and each of the pixels of the second pixel group has a positive offset voltage polarity H.

FIG. 4 schematically illustrates an offset removal algorithm according to another embodiment of the present invention.

According to another embodiment of the present invention, the polarity of an offset voltage is inverted using a line inversion method. Referring to FIG. 4, a plurality of pixels included in a display region are arranged in line patterns, and are classified into a first pixel group and a second pixel group, which are alternately arranged. The first pixel group and the second pixel group are controlled to have different offset voltage polarities, and the offset voltage polarities of the first pixel group and the second pixel group are inverted in each of a plurality of frames. For example, as illustrated in FIG. 4, in odd-numbered frames 402, each of the pixels of the first pixel group has a negative offset voltage polarity L, and each of the pixels of the second pixel group has a positive offset voltage polarity H, and in even-numbered frames 404, each of the pixels of the first pixel group has a positive offset voltage polarity H, and each of the pixels of the second pixel group has a negative offset voltage polarity L.

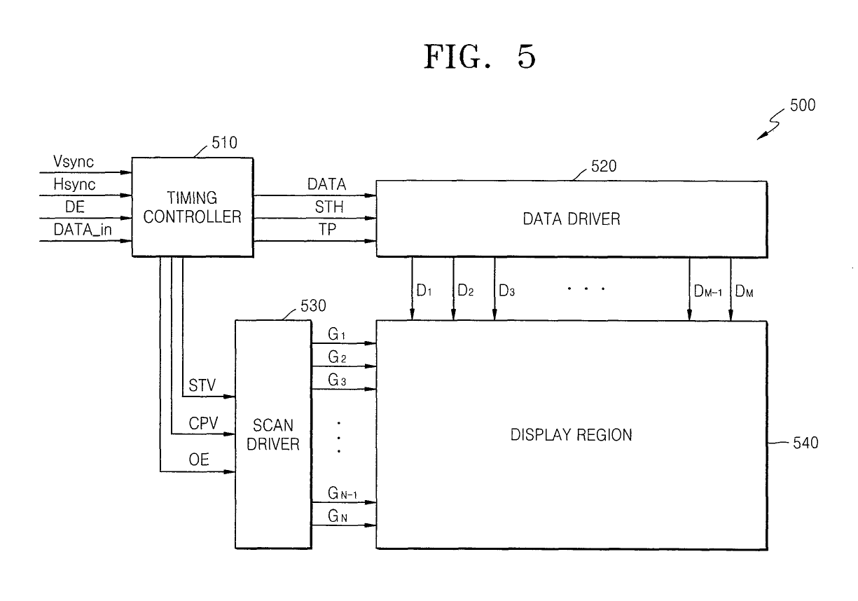

FIG. 5 schematically illustrates a structure of a display apparatus 500 according to an embodiment of the present invention. Referring to FIG. 5, the display apparatus 500 according to the present embodiment includes a timing controller 510, a data driver 520, a scan driver 530, and a display region 540.

The timing controller 510 receives a vertical synchronization (sync) signal Vsync, a horizontal sync signal Hsync, a data enable signal DE, and an image data signal DATA_in, and outputs a RGB data signal DATA, which is obtained by converting the image data signal DATA_in, to the data driver 520. The timing controller 510 also generates a start horizontal (STH) signal and a load signal TP that are used to provide a reference time period at which data voltages D₁, D₂, . . . , D_{M} are output to the display region 540 from the data driver 520, and outputs the STH signal and the load signal TP to the data driver 520.

Also, the timing controller 510 outputs a start vertical (STV) signal for selecting a first scan line, a gate clock signal CPV for sequentially selecting the next scan lines, and an output enable (OE) signal for controlling an output of the scan driver 530 to the scan driver 530.

The data driver 520 includes a plurality of data driver integrated circuits (ICs). The data driver 520 receives the RGB data signal DATA and the control signals STH and TP, which are input from the timing controller 510, generates the data voltages D₁, D₂, . . . , D_{M} corresponding to each of a plurality of data voltage channels, and applies the data voltages D₁, D₂, . . . , D_{M} to the display region 540.

The scan driver 530 includes a plurality of scan driver ICs. The scan driver 530 applies scan signals G₁, G₂, . . . , G_{N} to the scan lines of the display region 540 according to the control signals CPV, STV, and OE provided by the timing controller 510, to sequentially select each scan line.

The display region 540 is driven according to the scan signals G₁, G₂, . . . , G_{N} and the data voltages D₁, D₂, . . . , D_{M}, and includes a plurality of pixels that emit light according to the data voltages D₁, D₂, . . . , D_{M}. The plurality of pixels may be arranged in the form of a matrix, such as an M×N matrix (where M and N are natural numbers). Also, the pixels may emit light by using organic light emitting diodes (OLEDs), for example.

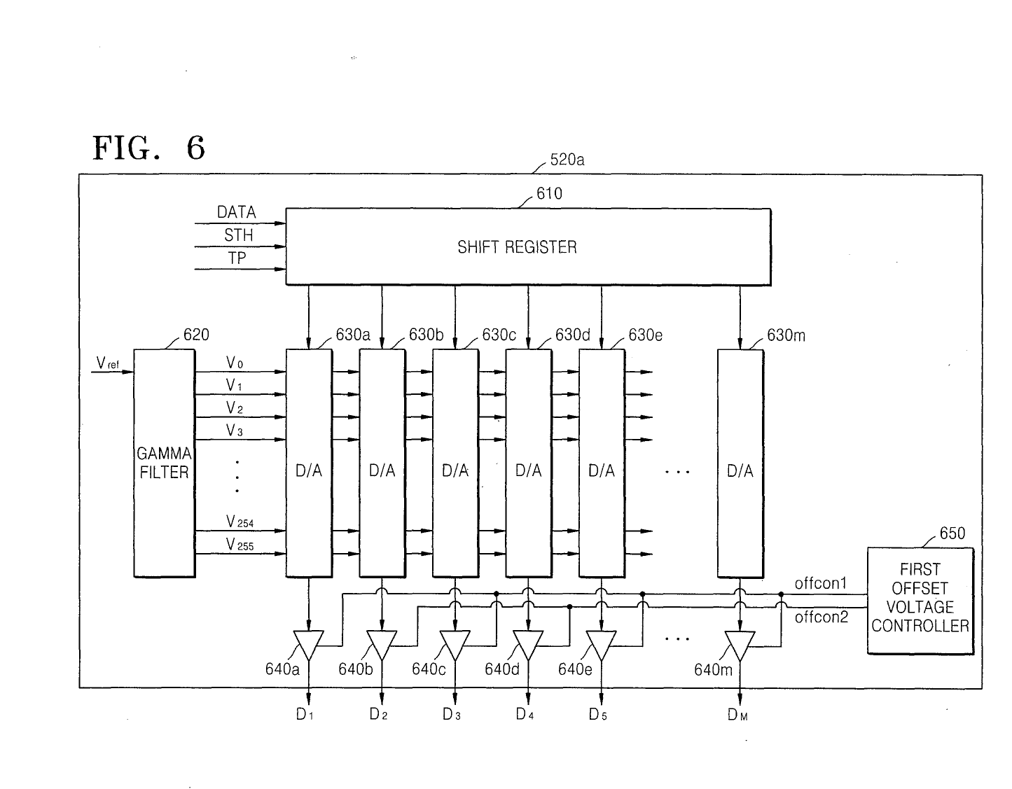

FIG. 6 illustrates the structure of a data driver 520a of the display apparatus shown in FIG. 5, according to an embodiment of the present invention. The data driver 520a according to the present embodiment performs offset removal by using a dot inversion method. Referring to FIG. 6, the data driver 520a includes a shift register 610, a gamma filter 620, a plurality of digital-analog converters 630a, 630b, . . . , 630m, a plurality of data voltage outputting units 640a, 640b, . . . , 640m, and a first offset voltage controller 650.

The shift register 610 receives the RGB data signal DATA and the control signals STH and TP, and outputs the RGB data signal DATA to the plurality of digital-analog converters 630a, 630b, . . . , 630m that correspond to data voltage channels, respectively.

The gamma filter 620 receives a reference voltage V_{ref}, generates a plurality of gamma voltages V₀, V₁, . . . , V₂₅₅, and applies the plurality of gamma voltages V₀, V₁, . . . , V₂₅₅ to the plurality of digital-analog converters 630a, 630b, . . . , 630m. The gamma filter 620 may generate different gamma voltages with respect to R, G, and B. Also, the number of the plurality of gamma voltages V₀, V₁, . . . , V₂₅₅ is not limited to 256, as shown in FIG. 6, and may be determined according to characteristics of the display apparatus 500.

The plurality of digital-analog converters 630a, 630b, . . . , 630m select gamma voltages from among the plurality of gamma voltages V₀, V₁, . . . , V₂₅₅ corresponding to the RGB data signal DATA, and outputs the selected gamma voltages to the data voltage outputting units 640a, 640b, 640c, . . . , 640m, respectively. To this end, the RGB data signal DATA output to each of the digital-analog converters 630a, 630b, . . . , 630m acts as a selection signal.

The plurality of data voltage outputting units 640a, 640b, 640c, . . . , 640m amplify the gamma voltages respectively input from the digital-analog converters 630a, 630b, . . . , 630m and output the data voltages D₁, D₂, . . . , D_{M} respectively to each of data voltage channels. The plurality of data voltage outputting units 640a, 640b, 640c, . . . , 640m may be implemented using an operational amplifier, etc. As described previously, the current-voltage characteristic of a transistor may not be matched due to variations in parameters, such as channel widths and lengths of transistors disposed at a differential input terminal of the operational amplifier, and as such, an undesired offset may occur. In FIG. 6, the plurality of data voltage outputting units 640a, 640b, 640c, . . . , 640m are controlled so that offset voltages of the plurality of pixels of the display region 540 may be inverted by using the dot inversion method, and the data driver 520a according to the present embodiment may include the first offset voltage controller 650. Also, in FIG. 6, the data voltage outputting units 640a, 640b, 640c, . . . , 640m are classified into a first group of outputting units 640a, 640c, . . . , 640m−1 and a second group of outputting units 640b, 640d, . . . , 640m, where the first offset voltage controller 650 controls the first group of outputting units 640a, 640c, . . . , 640m−1 and the second group of outputting units 640b, 640d, . . . , 640m separately. For example, the first group of outputting units 640a, 640c, . . . , 640m−1 and the second group of outputting units 640b, 640d, . . . , 640m may be alternately controlled.

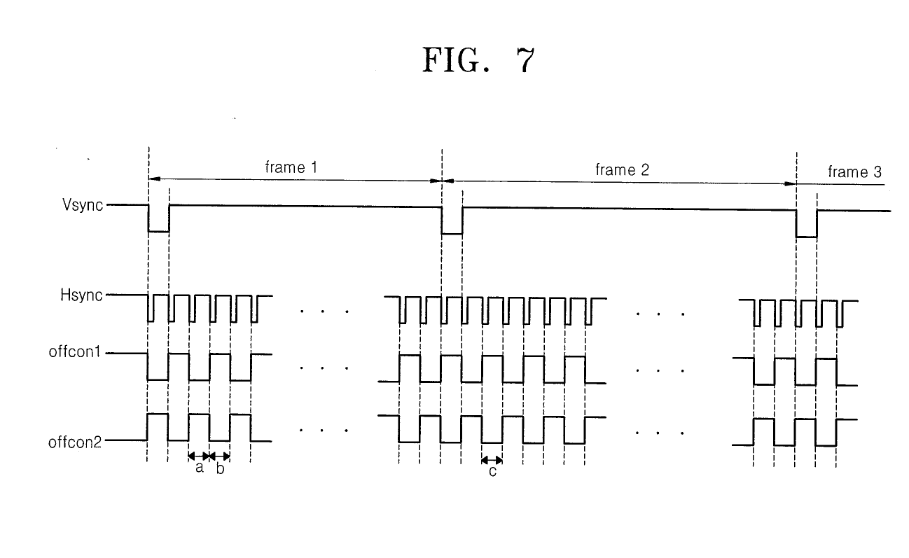

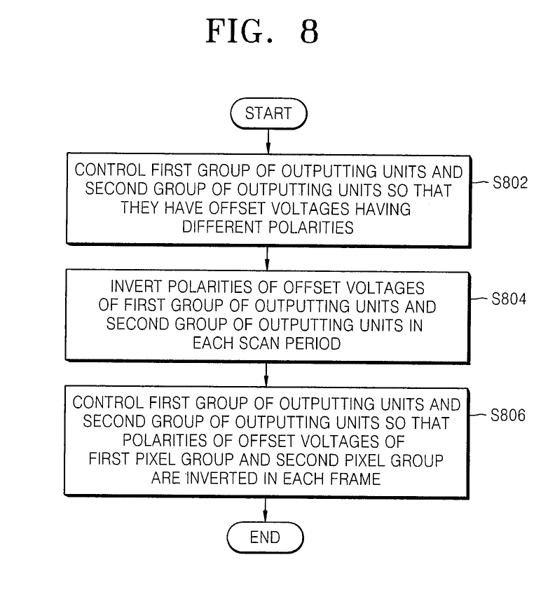

The first offset voltage controller 650 outputs a first offset voltage control signal offcon1 to control the first group of outputting units 640a, 640c, . . . , 640m−1, and outputs a second offset voltage control signal offcon2 to control the second group of outputting units 640b, 640d, . . . , 640m. The operation of the first offset voltage controller 650 will now be described in greater detail with reference to FIGS. 7 and 8.

FIG. 7 is a timing diagram illustrating a first offset voltage control signal offcon1 and a second offset voltage control signal offcon2 according to an embodiment of the present invention.

Referring to FIG. 7, one time period of the vertical sync signal Vsync represents one frame, and one time period of the horizontal sync signal Hsync represents one scan line. The first offset voltage control signal offcon1 and the second offset voltage control signal offcon2 are used so that an inversion input terminal and a non-inversion input terminal of a differential input terminal may be alternated according to the signal levels. For example, when the plurality of data voltage outputting units 640a, 640b, 640c, . . . , 640m include a first transistor (not shown) and a second transistor (not shown) that respectively receive a differential input signal, the first group of outputting units 640a, 640c, . . . , 640m−1 may be controlled so that, when the first offset voltage control signal offcon1 is at a high level, the first transistor operates as an inversion input terminal and the second transistor operates as a non-inversion input terminal, and when the first offset voltage control signal offcon1 is at a low level, the second transistor operates as an inversion input terminal and the first transistor operates as a non-inversion input terminal.

As illustrated in FIG. 7, the first offset voltage controller 650 controls the first group of outputting units 640a, 640c, . . . , 640m−1 and the second group of outputting units 640b, 640d, . . . , 640m so that their offset voltages may have opposite polarities (e.g., compare the first offset voltage control signal offcon1 with the second offset voltage control signal offcon2 in a time period a). Also, whenever a scan line is changed, the first offset voltage controller 650 inverts or switches the polarities of the offset voltages of the first group of outputting units 640a, 640c, . . . , 640m−1 and the second group of outputting units 640b, 640d, . . . , 640m (e.g., compare the time period a with a time period b). Furthermore, the first offset voltage controller 650 switches polarities of offset voltages of the plurality of pixels for each frame (e.g., compare the time period a with a time period c).

FIG. 8 is a flowchart illustrating a method of driving a display apparatus according to an embodiment of the present invention. Referring to FIG. 8, the method of driving the display apparatus according to the present embodiment includes controlling the first group of outputting units 640a, 640c, . . . , 640m−1 and the second group of outputting units 640b, 640d, . . . , 640m so that they have offset voltages having different polarities (S802). The control operation may be performed corresponding to the first offset voltage control signal offcon1 and the second offset voltage control signal offcon2, as described previously.

The method of driving the display apparatus of FIG. 8 further includes switching the offset voltage polarities of the first group of outputting units 640a, 640c, . . . , and 640m−1 and the second group of outputting units 640b, 640d, . . . , 640m in each scan period (S804). Also, the method of driving the display apparatus of FIG. 8 further includes controlling the first group of outputting units 640a, 640c, . . . , 640m−1 and the second group of outputting units 640b, 640d, . . . , 640m so that polarities of offset voltages of pixels corresponding to the first group of outputting units and pixels corresponding to the second group of outputting units arranged in dot patterns are switched for each frame (S806). The control operation may be performed corresponding to the first offset voltage control signal offcon1 and the second offset voltage control signal offcon2, as described previously with reference to FIG. 7.

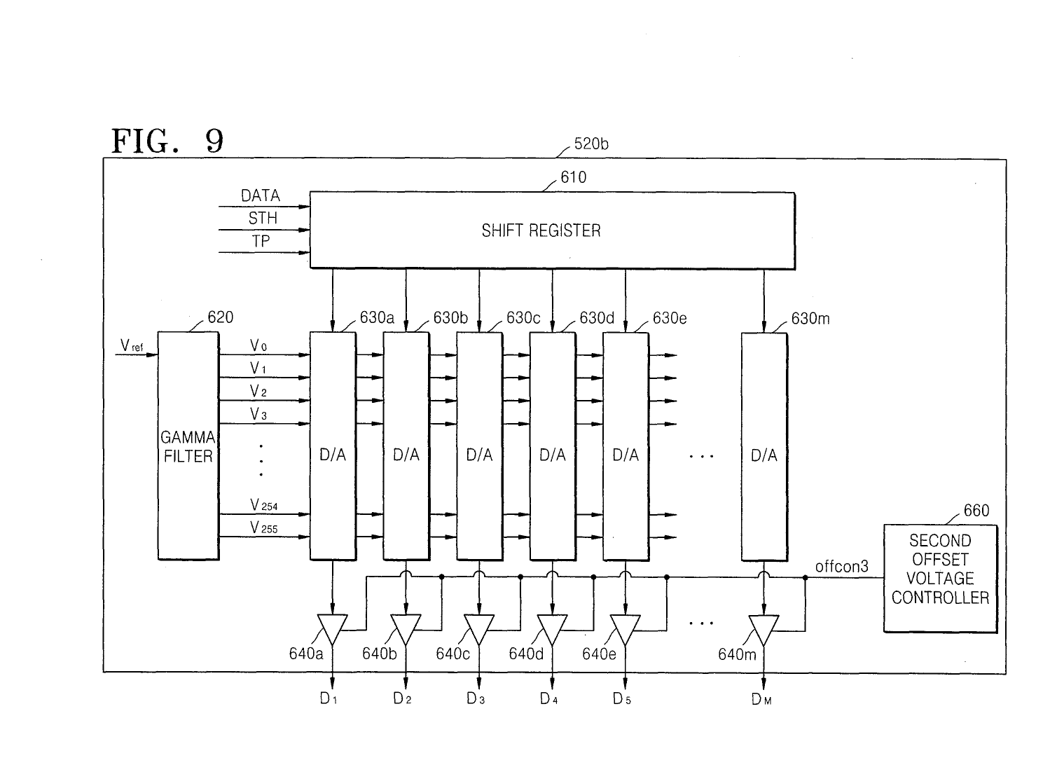

FIG. 9 illustrates the structure of a data driver 520b of the display apparatus shown in FIG. 5, according to another embodiment of the present invention. Referring to FIG. 9, the data driver 520b according to the present embodiment controls the plurality of data voltage outputting units 640a, 640b, 640c, . . . , 640m by using a line inversion method to switch offset voltages of a plurality of pixels. To this end, the data driver 520b includes a second offset voltage controller 660.

The second offset voltage controller 660 outputs a third offset voltage control signal offcon3 to control the plurality of data voltage outputting units 640a, 640b, 640c, . . . , 640m so that polarities of offset voltages of the data voltage outputting units 640a, 640b, 640c, . . . , 640m are switched using a line inversion method.

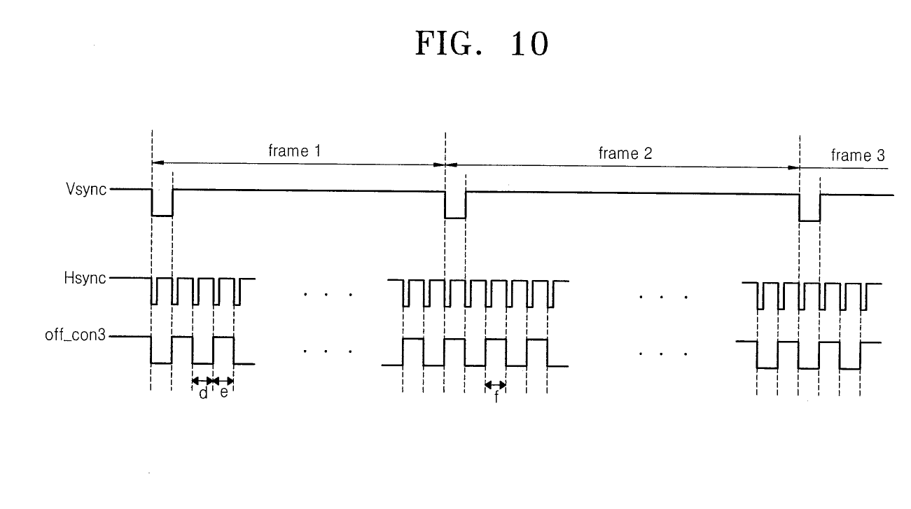

FIG. 10 is a timing diagram illustrating the third offset voltage control signal offcon3 according to another embodiment of the present invention. Referring to FIG. 10, the second offset voltage controller 660 transmits the third offset voltage control signal offcon3 so that the offset voltage polarities of the plurality of data voltage outputting units 640a, 640b, 640c, . . . , 640m may be switched for each line (e.g., compare a time period d with a time period e). Also, the second offset voltage controller 660 switches the polarities of offset voltages of the plurality of pixels for each frame (e.g., compare the time period d with a time period f).

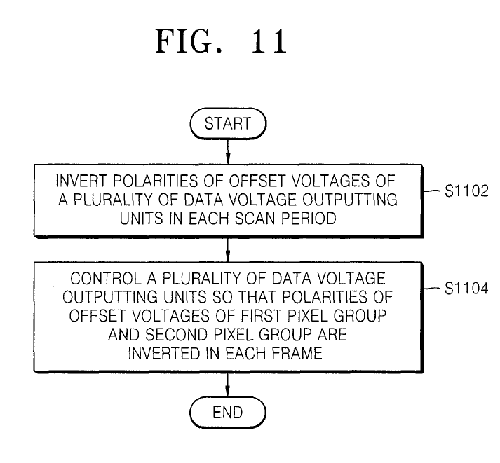

FIG. 11 is a flowchart illustrating a method of driving a display apparatus according to another embodiment of the present invention. Referring to FIG. 11, the method of driving the display apparatus according to the present embodiment includes controlling the plurality of data voltage outputting units 640a, 640b, 640c, . . . , 640m so that their offset voltage polarities are switched for each scan period (S1102). Also, the method of driving the display apparatus of FIG. 11 further includes controlling the plurality of data voltage outputting units 640a, 640b, 640c, . . . , 640m so that polarities of offset voltages of pixels corresponding to the first group outputting units and pixels corresponding to the second group outputting units arranged in line patterns are switched for each frame (S1104). The control operation may be performed corresponding to the third offset voltage control signal offcon3 of FIG. 10, as described previously.

As described above, in the offset removal algorithm according to exemplary embodiments of the present invention, by using a dot inversion method or a line inversion method, a sequential integration effect and a spatial integration effect with respect to variations in brightness due to an offset can be achieved. As such, occurrences of flickering can be prevented or reduced on a screen when the offset is efficiently removed or reduced.

While the present invention has been particularly shown and described with reference to exemplary embodiments thereof, it will be understood by those of ordinary skill in the art that various changes in form and details may be made without departing from the spirit and scope of the present invention as defined by the following claims.

What is claimed is:

1. A display apparatus comprising:
a display region comprising a plurality of pixels;
a data driver for outputting data voltages corresponding to input data to the plurality of pixels; and
a scan driver for outputting scan signals to the plurality of pixels,
wherein the plurality of pixels comprises a first pixel group and a second pixel group, and
wherein the first pixel group and the second pixel group have offset voltages having different polarities in a first frame, and the polarities of the offset voltages are inverted for each frame after the first frame.

2. The display apparatus of claim 1, wherein the first pixel group and the second pixel group are arranged in a dot pattern.

3. The display apparatus of claim 2, wherein the data driver comprises a plurality of data voltage outputting units for outputting the data voltages to the plurality of pixels via a plurality of data voltage channels, wherein the plurality of data voltage outputting units comprises a first group of outputting units and a second group of outputting units alternately arranged and having offset voltages having different polarities, and wherein the polarities of the offset voltages for the first group of outputting units and the second group of outputting units are inverted for each scan period.

4. The display apparatus of claim 3, wherein the data driver further comprises an offset voltage controller for outputting a first offset voltage control signal to the first group of outputting units and for outputting a second offset voltage control signal to the second group of outputting units, and wherein the first offset voltage control signal and the second offset voltage control signal have different logic levels and are utilized to invert the polarities of the offset voltages of the first group of outputting units and the second group of outputting units for each scan period, and to invert the polarities of the offset voltages of the first pixel group and the second pixel group for each frame.

5. The display apparatus of claim 1, wherein the first pixel group and the second pixel group are alternately arranged in a line pattern.

6. The display apparatus of claim 5, wherein the data driver further comprises a plurality of data voltage outputting units for outputting the data voltages to the plurality of pixels via a plurality of data voltage channels, and wherein polarities of the offset voltages of the plurality of data voltage outputting units are inverted for each scan period.

7. The display apparatus of claim 6, wherein the data driver further comprises an offset voltage controller for outputting an offset voltage control signal to the plurality of data voltage outputting units, and wherein the offset voltage control signal is utilized to invert the polarities of the offset voltages of the plurality of data voltage outputting units for each scan period, and to invert the polarities of the offset voltages of the first pixel group and the second pixel group for each frame.

8. The display apparatus of claim 1, wherein each of the plurality of pixels comprises an organic light emitting diode (OLED).

9. A method of driving a display apparatus comprising a display region comprising a plurality of pixels, a data driver for outputting data voltages corresponding to input data to the plurality of pixels, and a scan driver for outputting scan signals to the plurality of pixels, wherein the plurality of pixels comprises a first pixel group and a second pixel group, the method comprising:
controlling the first pixel group and the second pixel group to have offset voltages having different polarities in a first frame; and
inverting the polarities of the offset voltages of the first pixel group and the second pixel group for each frame after the first frame.

10. The method of claim 9, wherein the first pixel group and the second pixel group are arranged in a dot pattern.

11. The method of claim 10, wherein the data driver comprises a plurality of data voltage outputting units for outputting the data voltages to the plurality of pixels via a plurality of data voltage channels,
wherein the plurality of data voltage outputting units comprises a first group of outputting units and a second group of outputting units alternately arranged,
wherein the controlling of the first pixel group and the second pixel group comprises controlling the first group of outputting units and the second group of outputting units to have offset voltages having different polarities, and inverting the polarities of the offset voltages for the first group of outputting units and the second group of outputting units for each scan period, and
wherein the inverting of the polarities of the offset voltages of the first pixel group and the second pixel group comprises controlling the first group of outputting units and the second group of outputting units to invert the polarities of the offset voltages of the first pixel group and the second pixel group for each frame.

12. The method of claim 9, wherein the first pixel group and the second pixel group are alternately arranged in a line pattern.

13. The method of claim 12, wherein the data driver further comprises a plurality of data voltage outputting units for outputting the data voltages to the plurality of pixels via a plurality of data voltage channels,
wherein the controlling of the first pixel group and the second pixel group comprises inverting the polarities of the offset voltages of the plurality of data voltage outputting units for each scan period, and
wherein the inverting of the polarities of the offset voltages of the first pixel group and the second pixel group comprises controlling the plurality of data voltage outputting units to invert the polarities of the offset voltages of the first pixel group and the second pixel group for each frame.

14. The method of claim 9, wherein each of the plurality of pixels comprises an organic light emitting diode (OLED).
